(19) United States
(12) Patent Application Publication
(10) Pub. No.: US 2018/0320597 A1
(43) Pub. Date: Nov. 8, 2018

(54) METHOD FOR ASSEMBLING A TURBOMACHINE, AND TURBOMACHINE

(71) Applicant: Siemens Aktiengesellschaft, Munich (DE)

(72) Inventors: Dieter Nass, Moers (DE); Gregor Senyk, Neukirchen-Vluyn (DE)

(73) Assignee: Siemens Aktiengesellschaft, Munich (DE)

(21) Appl. No.: 15/772,959

(22) PCT Filed: Oct. 12, 2016
(86) PCT No.: PCT/EP2016/074486

§ 371 Date: May 2, 2018

(30) Foreign Application Priority Data
Nov. 10, 2015 (EP) 15193848.7

(51) Int. Cl. F02C 7/28

(52) U.S. Cl. CPC F02C 7/28; F05D 2220/31; F04D 29/403; F05D 2240/58; F05D 2230/60

(57) ABSTRACT

A method for assembling a turbomachine, the turbomachine has an inner part for arranging in an outer case, which has a parting joint extending along an axis and is divisible into an outer-case upper part and an outer-case lower part. The inner part has rotor parts for rotating about the axis during operation and static components and has at least one seal extending in the circumferential direction for sealing a gap between the inner part and a sealing surface of the outer case. The method includes: providing the outer-case lower part, inserting the inner part into the outer-case lower part in a first axial position, joining the outer-case lower part and outer-case upper part, axially moving the inner part in the outer case in relation to the outer case from the first axial position into an axial end position such that the seal comes in contact with the sealing surface.

### CROSS REFERENCE TO RELATED APPLICATIONS

This application is the US National Stage of International Application No. PCT/EP2016/074486 filed Oct. 12, 2016, and claims the benefit thereof. The International Application claims the benefit of European Application No. EP15193848 filed Nov. 10, 2015. All of the applications are incorporated by reference herein in their entirety.

### FIELD OF INVENTION

The invention relates to a method for assembling a turbomachine, wherein the turbomachine has an outer housing, wherein the turbomachine has an inner part for arrangement in the outer housing, wherein the outer housing has a parting joint, extending along an axis, such that the outer housing is formed so as to be dividable into an outer housing upper part and an outer housing lower part, wherein the inner part comprises rotor parts, provided for rotation about the axis during operation, and static components, wherein the inner part has at least one seal which extends in the circumferential direction and which serves for sealing off a gap between the inner part and a sealing surface of the outer housing. In addition, the invention relates to a turbomachine for assembly according to the method.

### BACKGROUND OF INVENTION

Turbocompressors which are intended for the assembly method of the type defined in the introduction are widely used in particular as relatively large machines. For example, a turbocompressor which has a horizontal parting joint is already described in the document WO 2013/121012 A1. In said document, it is shown in a simplified representation that an outer housing lower part is provided, an inner part is inserted into the outer housing lower part and an outer housing upper part is mounted on the outer housing lower part, so that, together with covers fitted on the inner part, which covers close off the end faces of the outer housing from the inside, a closed outer housing is the result. Shaft ends are guided out of the outer housing in order to transmit torques to the rotor of the turbocompressor. In principle, the turbomachine according to the invention and also according to the cited prior art is able to be implemented as a compressor or expander. Consequently, reference is often made only to a compressor, wherein generally the respective embodiment of the invention that the corresponding technical teaching is also applicable to an expander. The illustrations of FIG. 1 of WO 2013/121012 A1 are simplified such that exclusively the end-face covers of the outer housing are shown as stationary components of the inner part. In fact, situated between the different rotating impellers of the rotor are so-called intermediate bases, which prepare, in terms of flow, a process fluid for entry into the in each case subsequent stage. These so-called intermediate bases have not only the aerodynamic function of guiding the process fluid but also the task of sealing off with respect to differential pressures between the individual compression stages. This sealing function is generally realized by means of a circumferential seal between the inner part and the outer housing such that, for example, an O-ring seal, arranged in a circumferential groove on the inner part and pinched against a sealing surface on the inner side of the outer housing, provides a sealing action with respect to the differential pressure.

A disadvantage of the previous design and assembly methods is that, when the outer housing upper part is mounted onto the outer housing lower part, with the inner part inserted, the sealing element, which extends in the circumferential direction, is frequently damaged. Already when the inner part is inserted into the outer housing lower part, the sealing element is, above the parting joint region, pressed out, or pushed to form a bulge, to a greater or lesser degree as a result of the compression between the outer housing lower part and the inner part in the radial direction and because of the frictional force, acting in the circumferential direction, on the seal when the inner part is inserted. When the outer housing upper part is mounted, the sealing element is additionally compressed radially and is pressed out radially in the parting joint region to an even greater degree. In the final phase of the lowering of the outer housing upper part onto the outer housing lower part, the sealing element is in some cases clamped to such a degree in the parting joint region between the outer housing upper part and the outer housing lower part that the bulge which protrudes radially from the sealing groove there can be stripped. In this way, it is possible for the seal to be damaged already prior to the start-up and for leakages to already occur at the outset.

### SUMMARY OF INVENTION

It is an object of the invention to develop a method for assembly, and to further develop a turbomachine such that the above-described problems no longer occur.

In order to achieve said object, the invention proposes a method of the type mentioned in the introduction having the additional features of the characterizing part of the independent claim. In addition, the invention proposes a turbomachine as per the device claim. The dependent claims with respective back references encompass advantageous refinements of the invention.

In the terminology of the present document, terms such as “axial”, “radial” or “circumferential direction” at all times refer to the axis of the outer housing. Said axis is identical to, or at least parallel to, the axis of rotation of the turbomachine or of the rotor of the turbomachine.

The outer housing is referred to as “outer housing” because it externally surrounds the inner part. The same more or less applies conversely (mutatis mutandis) for the inner part.

The parting joint extending along the axis is advantageously formed to be substantially planar, with the result that a parting joint plane is obtained. Said parting joint plane extends at least parallel to the axis of the turbomachine. Within the imprecision of the production and the alignment tolerances of different components of the turbomachine with respect to one another, the axis of rotation of the rotor of the turbomachine is substantially situated in the parting joint plane during operation. The parting joint plane is radially aligned at least such that a problem-free insertion of the inner part into the outer housing is possible. The outer housing has on the axial end faces in each case one opening, this allowing shaft ends of the rotor of the inner part to be guided axially out of the outer housing at the end faces. Said shaft ends, which are provided at least on one axial side and are guided through axial openings of the outer housing, serve for the transmission of torques from and to the rotor of the turbomachine. Such an opening is in each case sealed off in the region of a gap between the shaft and the static components of the outer housing, which components define the opening, by means of at least one shaft seal.

Particularly advantageously, the outer housing has covers which close off the end faces and which form a jacket structure of the outer housing (an outer housing jacket), which structure is formed by the outer housing upper part and the outer housing lower part and is advantageously very substantially cylindrical, into a complete outer housing in a manner so as to close off the end faces.

A further refinement of the invention provides that the covers closing off the end faces of the outer housing bear, on the inside, against abutment shoulders of the outer housing jacket such that an inner pressure in the outer housing, which inner pressure is elevated in relation to the ambient pressure, presses said covers axially against said abutment shoulders.

Advantageously, the turbomachines according to the invention are systems in which an inner pressure which is elevated in relation to the external ambient pressure prevails at all times in the generic outer housing during normal operation.

Particularly advantageously, the cover provided in each case at an end face is, in the terminology of the invention, a constituent part of the inner part and is inserted into the outer housing lower part together with the rotor and possibly further non-rotating components in the context of the method according to the invention for assembly. For the axial guidance of shaft ends of the rotor out of the outer housing, the cover provided in each case at an end face has an opening. Said opening has, with the shaft of the rotor inserted, a gap formed in the circumferential direction between the opening contour and the shaft surface, which gap is advantageously able to be sealed off by means of at least one shaft seal. Advantageously, said shaft seal is fitted at the respective cover. Particularly advantageously, the cover is moreover a carrier of a radial bearing and possibly, at least on one axial side, of an axial bearing too. The fitting of these different components at the cover has the particular advantage that the alignment work of the shaft seal and the respective bearing arrangements in relation to one another is highly simplified, and the position and production tolerance chains are shortened, with the result that better precision can be achieved while maintaining the production and alignment effort.

In order that the cover provided at the respective axial end face and serving for closing off the outer housing is positioned in an axially secure manner in all operating states, it is expedient if the axial position of the cover is secured at the outer housing by means of special fastening elements or fastening devices.

Particularly advantageously, the inner housing is, at least sectionally, of cylindrical form such that an axial displacement of the inner housing in the outer housing is possible at least within the limits of the requirements according to the invention. Particularly expediently, it is also possible for the outer housing to be, at least sectionally, of cylindrical form such that no axial collisions between the inner housing and the outer housing occur within the context of the axial displacement according to the invention. For the purpose of the axial displacement, it is possible to provide between the inner housing and the outer housing a slide bearing arrangement of the corresponding cylinder sections of the inner housing outer contour and the outer housing inner contour. At least within the context of the axial displaceability, with regard to the inner contour, the outer housing should have a relatively long axial extent of the cylindrical geometry so that the inner housing is able to be displaced axially in the outer housing very substantially without resistance.

In order that the seal, which extends in the circumferential direction around the inner housing, is substantially radially contact-free when the inner part is lowered into the outer housing lower part and when the outer housing upper part is mounted onto the outer housing lower part, it is expedient if the inner surface of the outer housing has, in the corresponding axial position which is opposite the seal during the insertion, a depression which is widened radially in relation to the sealing surface axially adjacent thereto. In this connection, the sealing surface is that surface against which the seal, which extends in the circumferential direction, comes to bear in a sealing manner following completion of the axial displacement of the inner housing relative to the outer housing. Said depression may be formed as a groove extending in the circumferential direction. Here, said groove advantageously has a bevel formed to be of an order of magnitude of the seal (“order of magnitude” means here a groove depth of approximately 20%-100% of the radial dimension of the seal cross section, the bevel being able to have between 50%-100% of the depthwise extent of the groove depth and being able to be formed at 15°-20°, for example), said bevel preventing, within the context of the axial displacement of the inner housing, the possibility of the seal being damaged against the outer housing when entering the gap to be sealed.

### BRIEF DESCRIPTION OF THE DRAWINGS

Below, the invention is described in more detail on the basis of a specific exemplary embodiment with reference to drawings, in which:

FIGS. 1-5 show different steps of the method according to the invention for the assembly sequence in a schematic illustration;

FIG. 6 shows a schematic longitudinal section through a parting joint plane of a turbomachine according to the invention,

FIGS. 7, 8 each show a detail, which is identified by VII, VIII in FIGS. 3, 4, 5.

### DETAILED DESCRIPTION OF INVENTION

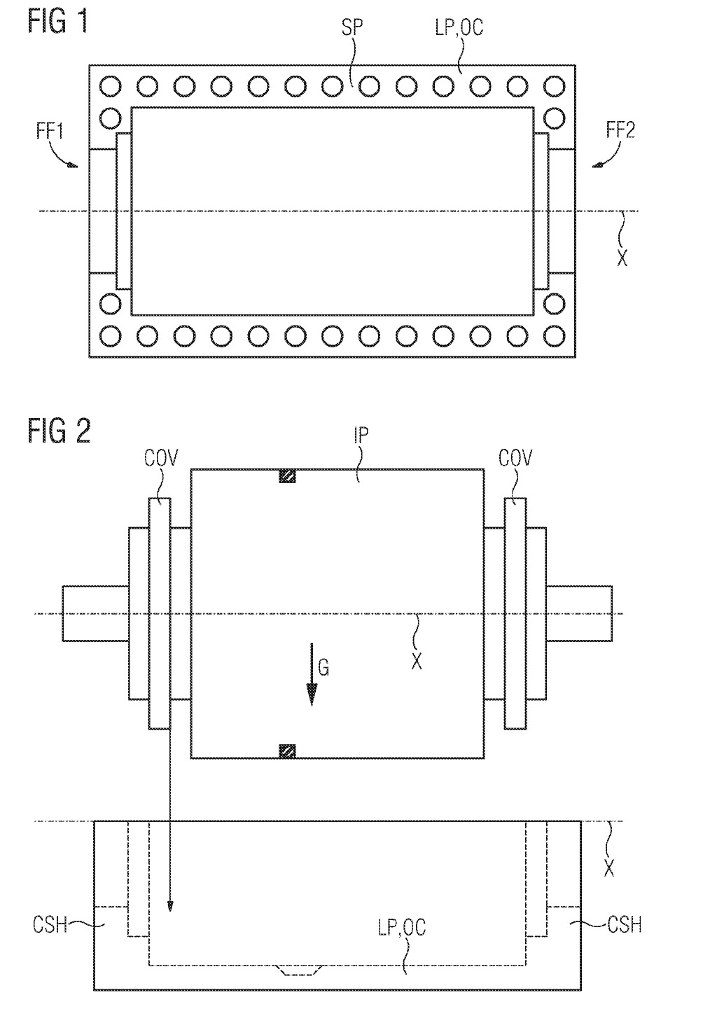

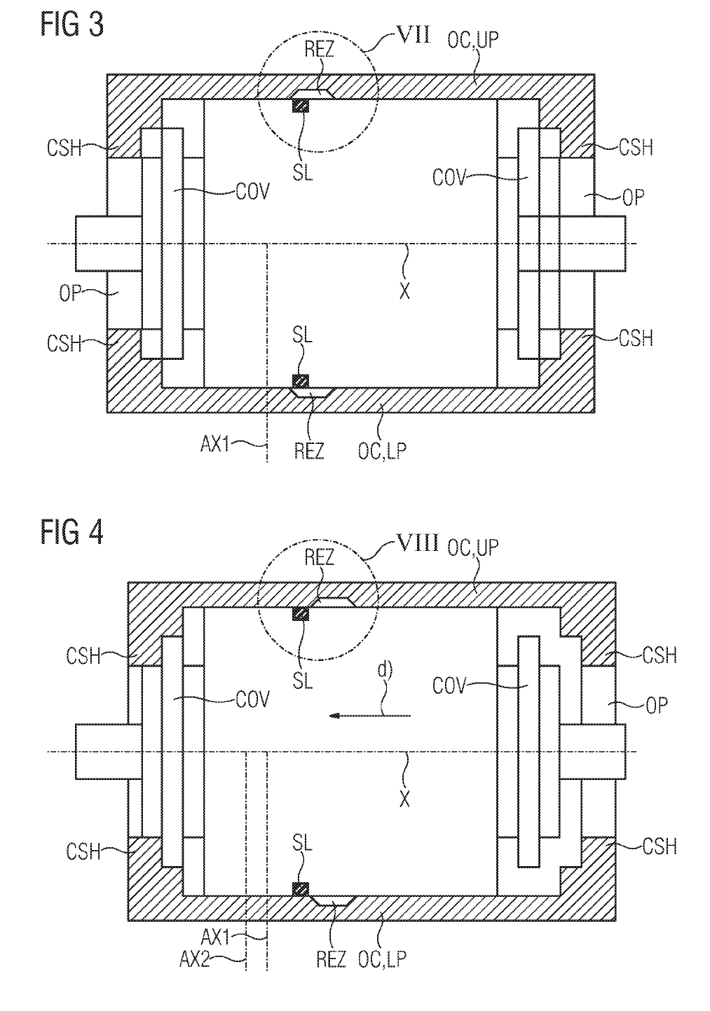

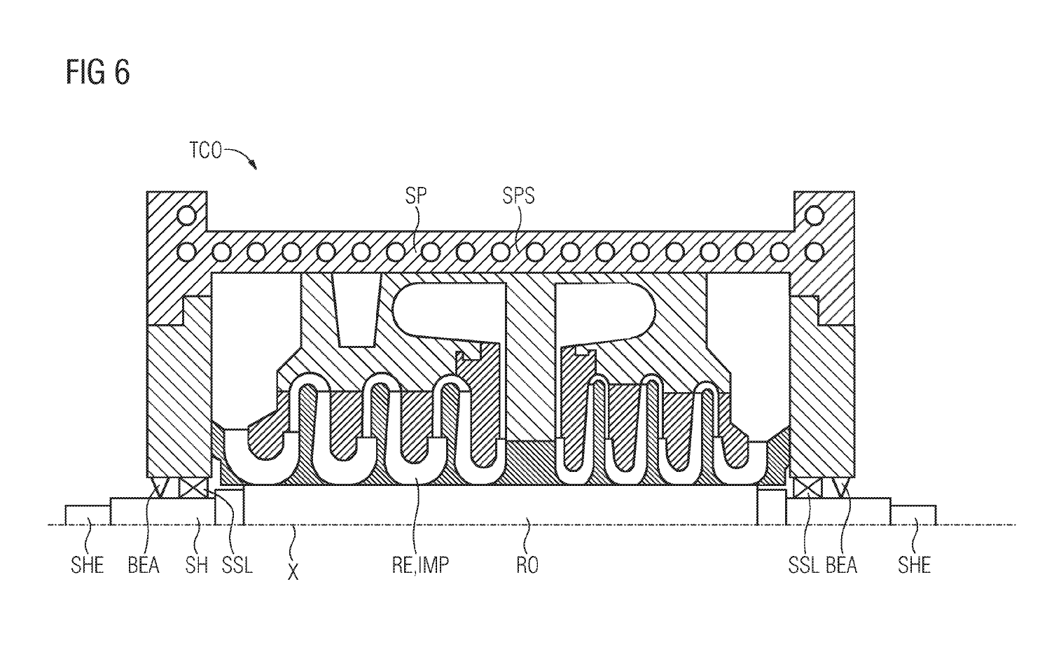

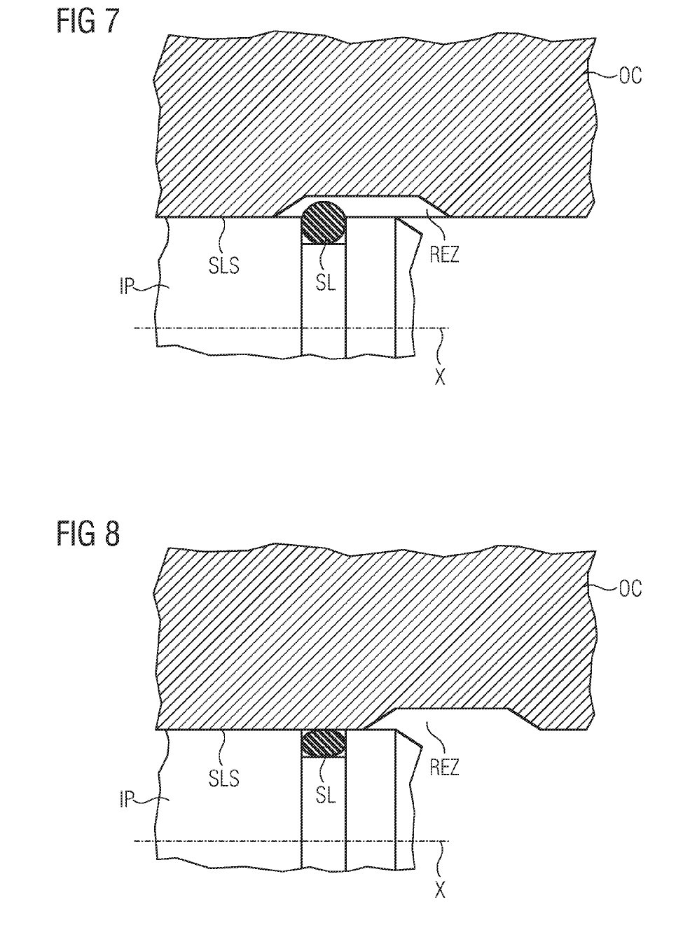

FIGS. 1 to 5 schematically show from, in part, different perspectives the sequence of a method according to the invention for the assembly of a turbomachine TCO according to the invention. FIG. 6 shows, in a schematic illustration, one radial half of a longitudinal section in a parting joint plane SPS along an axis X in this case equivalent to an axis of rotation—of a turbomachine TCO according to the invention. FIGS. 7 and 8 each show a detail, which is identified by VII, VIII in FIGS. 3, 4, 5.

Identical reference signs refer in each case to identical functions of at least very substantially identical structural elements. This specific figure description applies in each case throughout the figures, unless reference is made to a specific figure.

FIG. 1 shows the provision of an outer housing lower part LP of an outer housing OC of the turbomachine TCO according to the invention. The outer housing OC extends along an axis X which, on the one hand, is a longitudinal axis of the outer housing OC and, on the other hand, very substantially coincides with the axis of rotation (hereinafter also referred to simply as axis X) of a rotor RO (shown in FIG. 6), which rotor comprises rotor parts RE, for example impellers IMP, provided for rotation during operation. The outer housing OC has a parting joint SP which extends in a parting joint plane SPS along the axis X. The outer housing OC has on the axial end faces FF1, FF2 in each case one opening OP which is able to be closed off by means of a cover COV1, COV2.

As shown in FIG. 6, the impellers IMP are fitted on a shaft SH whose shaft ends SHE extend to outside the outer housing OC.

FIG. 2 illustrates a step b) of the method according to the invention, during which an inner part IP is inserted into the outer housing lower part LP. The radial insertion of the inner part IP is realized, with horizontal alignment of the axis X and very substantially following the action of gravitational force G, until the axis X of the inner part IP that is to say the axis of rotation of the rotor RO very substantially coincides with the axis X of the outer housing OC, with the result that the inner part IP comes to rest radially in a direct or indirect manner in the outer housing OC.

In FIG. 3, the completion of the joining together of the outer housing OC is illustrated, with the result that an outer housing upper part UP is mounted radially on the outer housing lower part LP such that the inner part IP is surrounded. The components identified in the exemplary embodiment as the outer housing lower part LP and the outer housing upper part UP form, in the joined-together state, an outer housing jacket which has end-face, axial openings OP. Covers COV1, COV2, serving as a constituent part of the inner part, which are provided for said openings for the purpose of closure have been introduced together with the inner part IP into the outer housing lower part LP. The outer housing OC is formed such that, in the completely-joined state, said covers COV1, COV2 come to bear axially against abutment shoulders CSH from the inside. At an elevated inner pressure, the covers COV1, COV2 are pressed in a sealing manner against said abutment shoulders CSH, wherein additional sealing elements (not illustrated in the figures) are provided for the purpose of sealing. FIG. 3 shows that the axial position of the inner part IP in relation to the outer housing OC corresponds to a first axial position AX1 such that a seal SL, extending in the circumferential direction, of the outer surface of the inner part IP is situated in the same axial position as a depression REZ provided on the inner side of the outer housing OC, with the result that the seal SL firstly does not come into contact with the outer housing OC.

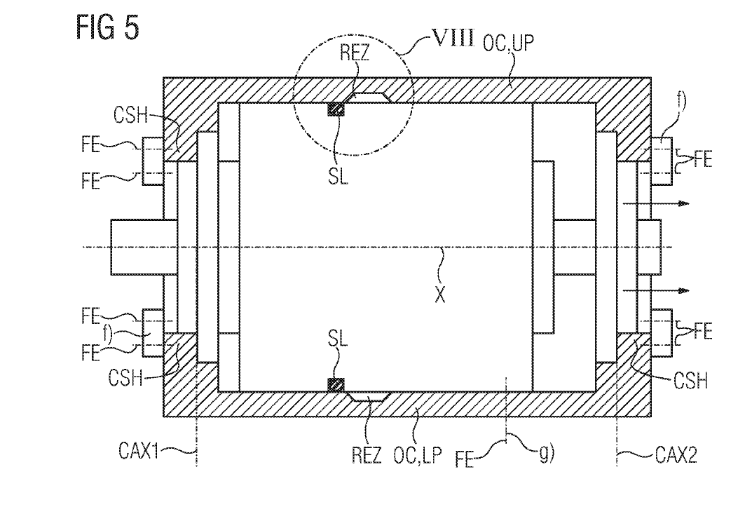

FIG. 4 shows the method step d) in which the inner part IP is displaced axially in relation to the outer housing OC. Within the context of this axial movement, the seal SL, which extends in the circumferential direction, comes into contact with a sealing surface SLS which is provided on the inner side of the outer housing OC and which extends in a circumferential direction. The details of this process can also be seen in FIGS. 7, 8. By way of example, it is possible for the sealing surface SLS to be produced with the radially opposite inner housing surface as a clearance fit pairing having the quality H7/g6. The depression REZ is provided with a bevel so that the seal SL is not damaged when axially entering the sealing position in which, while the seal SL is being pinched, radial contact with the sealing surface SLS results.

In FIG. 6, it is also shown that, particularly advantageously, the cover may additionally be a carrier of bearings BEA, in particular of a radial bearing and possibly, at least on one axial side, of an axial bearing too. In addition, the cover is also particularly well suited to serve as a carrier of a shaft seal SSL, as is illustrated in FIG. 6.

As an advantageous possible configuration of the invention, the figures additionally show that, during the axial displacement in step d), one cover COV1 also acquires its axial end position. This exemplary embodiment shows another advantageous possibility of displacing the inner part IP in that the displacement force on the inner part IP is applied indirectly to the inner part IP through the cover COV2 provided at the other side. In this connection, FIG. 5 shows that the two covers COV1, COV2 are each fastened or secured against axial displacement in their respective cover end positions CAX1, CAX2 by way of fastening elements FE at the in each case axial end faces FF1, FF2.

Alternatively and not illustrated in the exemplary embodiments, the inner part IP may be displaced in a manner substantially independent of the covers COV1, COV2. For this purpose, it may be provided for example that, firstly, the covers COV1, COV2 are brought into their axial cover end positions CAX1, CAX2 and, subsequently, the force required for the axial displacement of the inner part IP is transmitted directly to the inner part IP after the covers COV1, COV2 have been secured by means of an opening in the outer housing OC or in the covers COV1, COV2.

The pressure conditions in the turbomachine TCO may be formed for the operation such that the inner part IP remains in the axial end position AX2 due to axial thrusts. Additionally or alternatively, a mechanical securing means may be provided, which may be realized for example in the form of a mechanical clamping means. For example, said clamping means may be introduced or fastened through an opening in the outer housing OC, or through an opening at at least one cover COV1, COV2, in a manner not illustrated in more detail in the figures.

1. A method for assembling a turbomachine,
wherein the turbomachine has an outer housing,
wherein the turbomachine has an inner part for arrangement in the outer housing,
wherein the outer housing has a parting joint, extending along an axis, such that the outer housing is formed so as to be dividable into an outer housing upper part and an outer housing lower part,
wherein the inner part comprises rotor parts, provided for rotation about the axis during operation, and static components,
wherein the inner part has at least one seal which extends in the circumferential direction and which serves for sealing off a radial gaps between the inner part and a sealing surface of the outer housing,
the method comprising the steps of:
a) providing the outer housing lower part,
b) inserting the inner part into the outer housing lower part in a first axial position,
c) joining together the outer housing lower part and the outer housing upper part,
d) axially displacing the inner part in the outer housing relative to the outer housing from the first axial position into an axial end position such that the seal comes into contact with the sealing surface.

2. The method as claimed in claim 1,
wherein the outer housing has on at least one axial end face an opening which is closed off by means of a cover,
wherein the cover is a constituent part of the inner part,
wherein the cover is displaced axially with the inner part in step d), wherein, in a step e), the cover is displaced axially without the rest of the inner part in the direction which is opposite in relation to step d) such that the cover is moved into an axial cover end position in relation to the outer housing.

3. The method as claimed in claim 2,
wherein, in a step f), the cover is secured against axial displacement at the outer housing by means of fastening elements.

4. The method as claimed in claim 2,
wherein, in a step g), the inner part without the cover is secured against axial displacement at the outer housing or at the cover by means of fastening elements.

5. A turbomachine for assembly according to the method as claimed in claim 1,
wherein the turbomachine has an outer housing,
wherein the turbomachine has an inner part for arrangement in the outer housing,
wherein the outer housing has a parting joint, extending along an axis, such that the outer housing is formed so as to be dividable into an outer housing upper part and an outer housing lower part,
wherein the inner part comprises rotor parts, provided for rotation about the axis during operation, and static components,
wherein the inner part has at least one seal which extends in the circumferential direction and which serves for sealing off a gap between the inner part and a sealing surface of the outer housing,
wherein the inner part is formed so as to be displaceable in the outer housing between a first axial position and an axial end position,
wherein, adjacent to the sealing surface, the outer housing is formed such that, in the first axial position of the inner part inserted into the outer housing, the seal is not in contact with the outer housing, and the outer housing is furthermore formed such that, during a displacement from the first axial position into the axial end position, the seal comes into contact with the sealing surface of the outer housing.

6. The turbomachine as claimed in claim 5,
wherein a depression is provided adjacent to the sealing surface in the outer housing, with the result that the seal does not come into contact with the outer housing in the first axial position.

7. The turbomachine as claimed in claim 5,
wherein the outer housing has on at least one axial end face an opening which is closed off by means of a cover,
wherein the cover is a constituent part of the inner part,
wherein the cover is formed so as to be detachable from the inner part,
wherein, in an axial cover end position, the cover bears against an inner shoulder of the outer housing from axially inside such that an inner pressure in the outer housing pushes the cover axially against the inner shoulder.
